(19) United States
(12) Patent Application Publication
(10) Pub. No.: US 2025/0334160 A1
(43) Pub. Date: Oct. 30, 2025

(54) TEMPERATURE SENSOR STRUCTURE FOR BRAKE DISC AND ELECTRONIC PARKING BRAKE SYSTEM INCLUDING THE SAME

(71) Applicant: HL MANDO CORPORATION, Gyeonggi-do (KR)

(72) Inventor: YongKyun JUNG, Gyeonggi-do (KR)

(21) Appl. No.: 18/967,662

(22) Filed: Dec. 4, 2024

(30) Foreign Application Priority Data
Apr. 29, 2024 (KR) 10-2024-0056675

(51) Int. Cl. F16D 66/00; G01K 1/08; G01K 1/14

(52) U.S. Cl. CPC F16D 66/00; G01K 1/08; G01K 1/14; F16D 2066/001

(57) ABSTRACT

A temperature sensor structure for a brake disc and an electronic parking brake system including the same is provided. The temperature sensor structure for a brake disk according to an embodiment of the present disclosure comprises: a front housing having a transparent window member provided on a front surface facing the brake disc; a sensor module including a sensor for measuring the temperature of the brake disc; a bracket coupled to the rear of the front housing and supporting the sensor module; and a rear housing coupled to the rear side of the bracket, wherein the plane including the transparent window member is disposed to be inclined at a predetermined angle with an opposite surface of the brake disc where the sensor measures the temperature.

### CROSS REFERENCE TO RELATED APPLICATION

This application claims priority to and the benefit of Korean Patent Application No. 10-2024-0056675, filed on Apr. 29, 2024, the disclosure of which is incorporated herein by reference in its entirety.

### BACKGROUND

### 1. Technical Field

The present disclosure relates to a temperature sensor structure for a brake disc and an electronic parking brake system including the same, and more specifically, to a temperature sensor structure for a brake disc installed adjacent to a brake disc of a vehicle to measure the temperature of the brake disc and an electronic parking brake system including the same.

### 2. Discussion of Related Art

Generally, a brake device has a parking brake, commonly called a hand brake or a side brake, which keeps the vehicle in a stopped state.

The parking brake is operated by the driver operating a parking lever provided on one side of the driver's seat inside the vehicle. When the driver pulls the parking lever and the cable connected thereto is pulled, the rear wheel brake assembly connected to the cable is operated to secure braking power, and conversely, when the parking lever is released and the cable is released, the braking power is released.

However, since the operation of the parking brake according to the operation of the parking lever is performed only by the driver's will, if the driver carelessly parks the vehicle on a slope, etc. without pulling the parking lever, the vehicle may roll down, causing an unexpected accident.

In addition, since the driver must operate the parking lever every time the vehicle is parked or started to drive, there is a problem that its use is very cumbersome, especially for women or the elderly who have weak strength.

Therefore, recently, an electronic parking brake (EPB) system that electronically controls the operation of the parking brake is being used, which is mounted on a conventional disc brake to perform the function of the parking brake.

The electronic parking brake system enables the parking brake to be automatically applied or released according to a simple switch operation or a control judgment of an electronic control unit (ECU) which is in charge of overall control, even if the driver does not manually apply the parking brake.

The electronic parking brake system includes an actuator having a motor that generates braking force, and an electronic control unit (ECU) for driving the actuator.

The electronic control unit (ECU) includes an MCU, multiple sensor interfaces, a motor drive, and a communication module. The electronic control unit (ECU) drives the actuator according to the operation status of the switch to apply or release the electronic parking brake system.

In this case, the measurement of the brake disc temperature may be important in relation to the operation of the electronic parking brake system. The measurement of the brake disc temperature may include a method of directly measuring the temperature of the brake disc surface and a method of estimating the surface temperature of the brake disc.

Among them, in the case of directly measuring the temperature of the brake disc, the location and structure of the brake disc temperature sensor structure for installing the temperature sensor around the brake disc may be important factors in measuring the temperature of the brake disc.

In particular, the brake disc generates dust as it wears during vehicle operation, and if the dust generated from the brake disc accumulates on the surface of the temperature sensor, it may not be easy to measure the temperature of the brake disc.

In addition, in order to accurately measure the temperature of the brake disc using the temperature sensor, it is necessary to develop a temperature sensor structure to ensure that the temperature sensor can be stably installed around the brake disc of the vehicle.

### SUMMARY

The present disclosure is to solve the above problems, and an object of the present disclosure is to provide a temperature sensor structure for a brake disc capable of accurately measuring the temperature of a brake disc.

Another object of the present disclosure is to provide a temperature sensor structure for a brake disc formed so that dust generated from a brake disc does not accumulate in the temperature sensor structure while measuring the temperature of the brake disc, so that the dust generated from the brake disc does not interfere with the temperature measurement.

Still another object of the present disclosure is to provide a temperature sensor structure for a brake disc that can be firmly mounted at a position adjacent to the surface of a brake disc so as to accurately measure the temperature of the brake disc.

Yet another object of the present disclosure is to provide a temperature sensor structure having a housing structure that can stably protect the temperature sensor without being affected by the surrounding environment inside a vehicle in which a brake disc is placed while the temperature sensor structure for measuring the temperature of the brake disc is installed adjacent to the brake disc.

The objects of the present disclosure are not limited to the above-described objects, and other objects that are not mentioned will be able to be clearly understood by those skilled in the art to which the present disclosure pertains from the following description.

According to one aspect of the present disclosure, there is provided a temperature sensor structure for a brake disc, comprising: a front housing having a transparent window member provided on a front surface facing the brake disc; a sensor module including a sensor for measuring the temperature of the brake disc; a bracket coupled to the rear of the front housing and supporting the sensor module; and a rear housing coupled to the rear side of the bracket, wherein the plane including the transparent window member is disposed to be inclined at a predetermined angle with an opposite surface of the brake disc where the sensor measures the temperature.

In this case, the transparent window member may include an IP filter, and the sensor may be an IR sensor.

An accommodation groove in which the transparent window member is accommodated may be formed on the front surface of the front housing, and the front surface of the transparent window member accommodated in the accommodation groove and the front surface of the front housing may be disposed on the same plane.

The sensor module may include a PCB substrate and the sensor mounted on one surface of the PCB substrate.

The PCB substrate may be fixed in a bracket hole formed in the bracket by a substrate fixing member formed at the circumference of the PCB substrate.

The bracket may include a bracket body through which the bracket hole is formed toward the front housing; an extension portion formed to protrude in both lateral directions on both sides of the bracket hole, wherein the extension portion may have a first through hole through which a predetermined fastening member can pass.

The front housing may be formed to have a sensor accommodation space in which the sensor of the sensor module is accommodated, and the rear end of the front housing may be formed to have an opening so that the sensor accommodation space is opened toward the rear side of the front housing, wherein a coupling part for coupling the front housing to the front of the bracket hole may be provided at the circumference of the opening.

The rear housing may include a rear housing body having a flat shape facing the PCB substrate; and a side wall portion protruding from the rear housing body and coupled to the inner surface of the bracket hole.

In this case, an external terminal connection part extending toward the rear side of the rear housing body may be further included, and the PCB substrate may be provided with a terminal part so that the sensor can be connected to the outside through the external terminal connection part.

In this case, a sealing member provided at the outer circumference of the side wall portion to seal between the inner surface of the bracket hole and the side wall portion may be further included.

A second through hole may be formed at the circumference of the rear housing body so that a predetermined coupling member for fastening the rear housing to the bracket can pass therethrough.

The axis passing through the center of the sensor may be formed to meet the axis passing through the center of the brake disc at one point, and the sensor may be disposed to be inclined in a direction toward the outside of the brake disc with respect to the brake disc.

The distance from the transparent window member to a point where the axis passing through the center of the sensor meets the surface of the brake disc may be in the range of 35 mm to 40 mm, and the angle at which the axis passing through the center of the sensor is inclined with the opposite surface of the brake disc may be in the range of 20 to 30 degrees.

The bracket may be coupled to one side of a knuckle of a vehicle in which the temperature sensor structure is installed.

According to another aspect of the present disclosure, there is provided a temperature sensor structure for a brake disc installed on one side of a vehicle knuckle adjacent to the brake disc to measure the temperature of the brake disc of the vehicle, the temperature sensor structure including: a housing having a transparent window member disposed to be inclined at a predetermined angle toward the brake disc at the front; a temperature measurement sensor positioned inside the housing to measure the temperature of the brake disc through the transparent window member; and a bracket coupled to the housing to couple the housing to the knuckle.

In this case, the transparent window member may include an IP filter, and the sensor may be an IR sensor.

The front surface of the transparent window member and the front surface of the housing may be disposed on the same plane.

The inside of the housing where the temperature measurement sensor is positioned may be formed to have a watertight structure.

The housing may include a front housing in which the temperature measurement sensor is positioned and the transparent window member is provided in front of the temperature measurement sensor, and which is coupled to one side of the bracket, and a rear housing coupled to the other side of the bracket.

According to another aspect of the present disclosure, there is provided an electronic parking brake system comprising the temperature sensor structure for a brake disc.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a perspective view showing a state in which a temperature sensor structure for a brake disc according to an embodiment of the present disclosure is installed in a knuckle of a vehicle.

FIG. 2 is a perspective view of a temperature sensor structure for a brake disc according to an embodiment of the present disclosure.

FIG. 3 is an exploded perspective view of a temperature sensor structure for a brake disc according to an embodiment of the present disclosure as viewed from the front.

FIG. 4 is an exploded perspective view of a temperature sensor structure for a brake disc according to an embodiment of the present disclosure as viewed from the rear.

FIG. 5 is a cross-sectional view taken along line I-I′ in FIG. 1.

FIG. 6 is a side view showing a surface of a brake disc and an arrangement of a temperature sensor structure in a state in which a temperature sensor structure for a brake disc according to an embodiment of the present disclosure is installed in a knuckle.

### DETAILED DESCRIPTION OF EXEMPLARY EMBODIMENTS

Hereinafter, embodiments of the present disclosure will be described in detail so that those skilled in the art to which the present disclosure pertains can easily carry out the embodiments. The present disclosure may be implemented in many different forms and is not limited to the embodiments described herein. In order to clearly describe the present disclosure, portions not related to the description are omitted from the accompanying drawings, and the same or similar components are denoted by the same reference numerals throughout the specification.

The words and terms used in the specification and the claims are not limitedly construed as their ordinary or dictionary meanings, and should be construed as meaning and concept consistent with the technical spirit of the present disclosure in accordance with the principle that the inventors can define terms and concepts in order to best describe their invention.

In the specification, it should be understood that the terms such as “comprise” or “have” are intended to specify the presence of features, numbers, steps, operations, components, parts, or combinations thereof described in the specification and do not preclude the possibility of the presence or addition of one or more other features, numbers, steps, operations, components, parts, or combinations thereof.

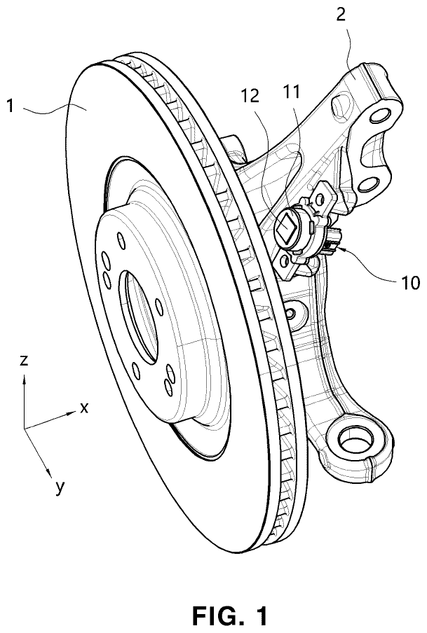

FIG. 1 is a perspective view showing a state in which a temperature sensor structure for a brake disc according to an embodiment of the present disclosure is installed in a knuckle of a vehicle.

Referring to FIG. 1, the temperature sensor structure 10 for a brake disc according to an embodiment of the present disclosure is installed in one side of a knuckle 2 to measure the surface temperature of a brake disc 1.

The temperature sensor structure 10 may be coupled to one side of the knuckle 2 by a fastening member (not shown) such as a bolt, and in order to couple the temperature sensor structure 10 to one side of the knuckle 2, the knuckle 2 may be provided with a fastening member coupling hole to which a fastening member for coupling the temperature sensor structure 10 can be coupled.

However, in order to couple the temperature sensor structure 10 to one side of the knuckle 2, a known coupling method may be used in addition to a fastening member such as a bolt.

In one embodiment of the present disclosure, referring to FIG. 1, the temperature sensor structure 10 is disposed to be inclined to face one surface of the brake disc 1 so that the temperature sensor faces upward toward the opposite surface of the brake disc 1.

In addition, as shown in FIG. 1, a front surface 11 of the temperature sensor structure 10 facing the brake disc 1 is formed as a plane. The front surface 11 of the temperature sensor structure 10 is provided with a flat transparent window member 12, and a temperature sensor is disposed inside the housing of the temperature sensor structure 10 so that the surface temperature of the brake disc 1 can be measured through the transparent window member 12. In one embodiment of the present disclosure, the front surface 11 of the temperature sensor structure 10 and the flat transparent window member 12 are manufactured to be placed on the same plane or to be disposed almost parallel to each other.

Accordingly, the temperature sensor structure 10 for measuring the brake disc 1 can measure the temperature of the upper surface of one side facing the x-axis direction of the brake disc 1 as seen in FIG. 1.

according to an embodiment of the present disclosure, when the direction of movement of the vehicle is the negative direction of the y-axis in FIG. 1, the dust worn and separated from the brake disc 1 is scattered from the brake disc 1 in the positive direction of the y-axis or the negative direction of the z-axis, which is the direction of gravity.

Accordingly, in one embodiment of the present disclosure, the front surface 11 of the temperature sensor structure 10 is arranged to be inclined upward with respect to the opposing surface of the brake disc 1, and the transparent window member 12 is formed as a plane. In this case, since the front surface 11 of the temperature sensor structure 10 and the flat transparent window member 12 are disposed on the same plane, dust does not accumulate on the surface of the temperature sensor structure 10.

Hereinafter, a detailed structure of the temperature sensor structure 10 for a brake disc will be described using different drawings.

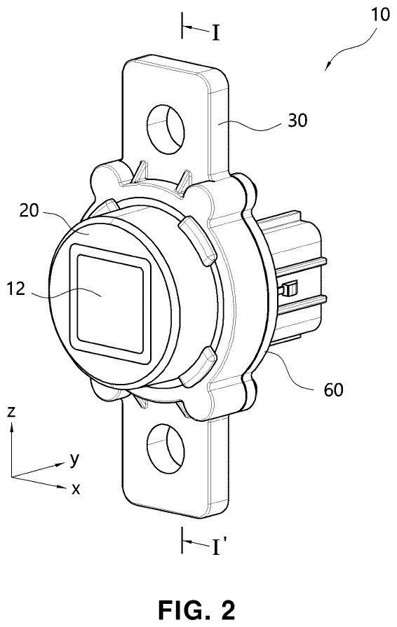

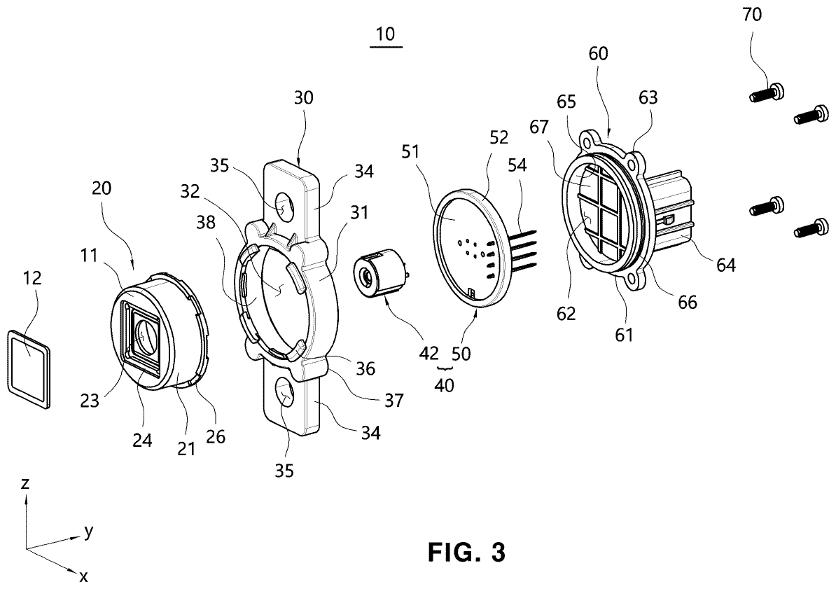

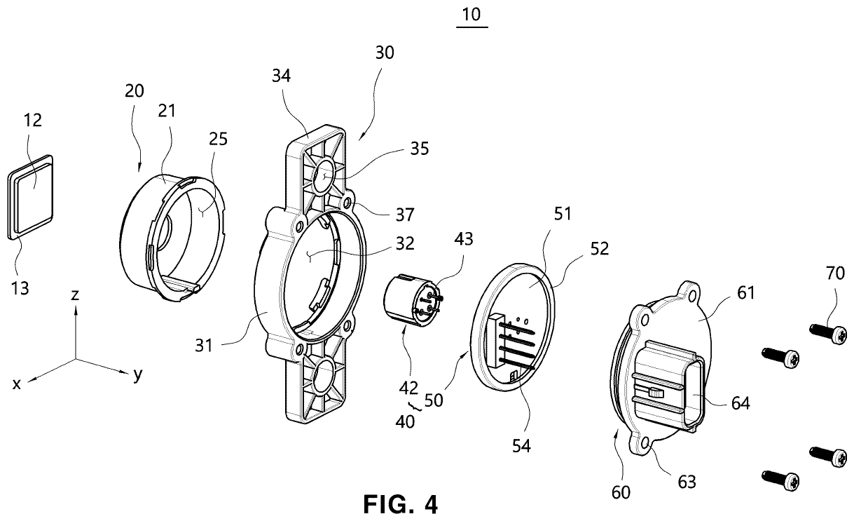

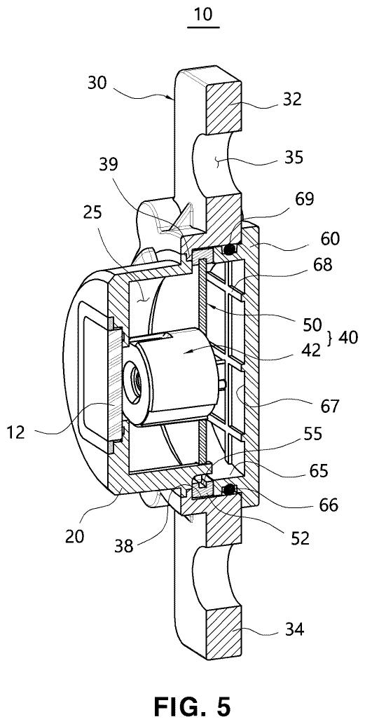

FIG. 2 is a perspective view of a temperature sensor structure for a brake disc according to an embodiment of the present disclosure. FIG. 3 is an exploded perspective view of a temperature sensor structure for a brake disc according to an embodiment of the present disclosure as viewed from the front. FIG. 4 is an exploded perspective view of a temperature sensor structure for a brake disc according to an embodiment of the present disclosure as viewed from the rear. FIG. 5 is a cross-sectional view taken along line I-I′ in FIG. 1. The xyz coordinate system illustrated in FIGS. 2 to 5 is a coordinate system set centered on the temperature sensor structure, unlike the xyz coordinate system of FIG. 1.

Referring to FIGS. 2 to 5, the temperature sensor structure 10 according to an embodiment of the present disclosure includes a front housing 20, a sensor module 40, a bracket 30, and a rear housing 60. In this specification, when viewed in FIGS. 2 to 5, a negative direction of the y-axis is defined as a front, and a positive direction of the y-axis is defined as a rear. The front housing 20 and the rear housing 60 may be collectively defined as a housing of the temperature sensor structure.

Referring to FIGS. 2 to 5, in the temperature sensor structure 10 according to an embodiment of the present disclosure, the front housing 20 includes a cylindrical front housing body 21 having an accommodation groove 24 in which a transparent window member 12 can be installed on a front surface 11 facing forward, and a cylindrical side surface extending from the front surface 11 to the rear.

An accommodation space 25 is formed inside the cylindrical front housing body 21 to accommodate the sensor structure 42.

In one embodiment of the present disclosure, the shape of the front housing 20 is illustrated as a cylindrical shape, but the shape of the front housing 20 is not limited to the cylindrical shape, and may be any shape as long as the transparent window member 12 may be provided on the front surface and a space in which the sensor structure 42 can be accommodated may be provided.

In one embodiment of the present disclosure, the front housing 20 may be formed of metal or synthetic resin material, etc.

Meanwhile, according to an embodiment of the present disclosure, the accommodation groove 24 of the front housing 20 has a square shape, and a through hole 23 is formed toward the rear inside the accommodation groove 24 of the front housing 20.

The transparent window member 12 may be accommodated in and coupled to the accommodation groove 24. A stepped portion 13 is formed at the circumference of the transparent window member so that the transparent window member 12 is accommodated in and coupled to the accommodation groove 24. Although not shown, an adhesive such as an epoxy may be applied at the circumference of the transparent window member 12 so that the transparent window member 12 can be coupled to the accommodation groove 24.

The transparent window member 12 can protect the sensor structure 42 located inside the front housing 20 when the sensor structure 42 passes through the transparent window member 12 to sense the surface temperature of the brake disc 1.

In an embodiment of the present disclosure, the transparent window member 12 may have a square shape and may be formed of a transparent material with a predetermined thickness, for example, an IR filter.

The IR filter of the transparent window member 12 can allow only a desired IR wavelength band to pass through and enter the IR sensor.

In one embodiment of the present disclosure, the transparent window member 12 is formed so that the front surface exposed to the outside is positioned on the same plane or almost parallel to the front surface 11 of the front housing 20 when inserted into the accommodation groove 24 and coupled thereto.

Accordingly, when dust from the brake disc 1 is scattered in the positive direction of the x-axis or the negative direction of the z-axis as viewed in FIG. 2, it may not accumulate on the front surface 11 of the front housing 20 and around the transparent window member 12.

Meanwhile, a coupling groove 26 is formed at the rear end of the cylindrical side surface of the front housing 20.

The coupling groove 26 is a portion formed to allow a bracket 30 described later and the front housing 20 to be coupled to each other. In an embodiment of the present disclosure, the bracket 30 may be provided with a coupling protrusion 36 to be coupled to the coupling groove 26 of the front housing 20. A detailed structure thereof will be described later.

Meanwhile, according to an embodiment of the present disclosure, the bracket 30 is coupled to the rear of the front housing 20.

The bracket 30 includes a bracket body 31 having a bracket hole 32 formed in the center in the y-axis direction, i.e., the front-rear direction as viewed in FIG. 3.

The bracket body 31 has a cylindrical shape extending in the front-rear direction, and as shown in FIGS. 2 and 3, an extension portion 34 is formed to protrude in the vertical direction at the upper and lower parts of the bracket body 31 in the z-axis direction.

A fastening member through hole 35 is formed through the extension portion 34 in the y-axis direction. A fastening member (not shown) may pass through the fastening member through hole 35 to couple the bracket 30 to a predetermined position in the vehicle, for example, one side of the knuckle 2.

Meanwhile, referring to FIG. 3, a coupling protrusion 36 that may be coupled to the coupling groove 26 of the front housing 20 is formed at the front end edge of the bracket hole 32.

In the present embodiment, four coupling protrusions 36 are formed and are spaced apart along the circular end edge of the bracket hole 32.

The coupling protrusion 36 is formed to be coupled to the coupling groove 26 of the front housing 20 by fitting and coupling.

By forming the coupling protrusion 36 so that it can be coupled to the coupling groove 26 of the front housing 20 in a fitting manner as described above, the front housing 20 can be simply coupled to the bracket 30 or separated if necessary.

In this embodiment, in order to couple the rear end of the front housing 20 to the bracket 30, a coupling groove 26 is formed at the rear end of the front housing 20 and a coupling protrusion 36 is formed at the front edge of the bracket hole 32 to be coupled in a fitting manner. However, various known coupling structures may be applied to the structure for coupling the front housing 20 to the bracket 30.

Meanwhile, in an embodiment of the present disclosure, a sensor module 40 is formed to be coupled to the inner surface 38 of the bracket hole 32.

According to an embodiment of the present disclosure, the sensor module 40 may include a sensor structure 42 and a PCB substrate structure 50. The PCB substrate structure 50 may include a PCB substrate 51 and a substrate fixing bumper 52 for coupling the PCB substrate 51 to the inner surface of the bracket hole 32.

Referring to FIG. 3, the sensor structure 42 may be formed in a cylindrical shape and have a built-in sensor, for example, an IR sensor, and an irradiation part capable of irradiating infrared rays toward the front. Since the sensor structure 42 has a known configuration, a detailed description thereof will be omitted.

Meanwhile, in one embodiment of the present disclosure, the sensor structure 42 may be formed such that a terminal part 43 formed on the rear side is electrically connected to the front surface of the PCB substrate 51.

The PCB substrate 51 to which the sensor structure 42 is coupled may be formed in a disc shape so as to be inserted into the bracket hole 32, and a terminal part 54 extending toward the rear side is coupled to one side of the PCB substrate 51.

The terminal part 54 protrudes outwardly from the rear housing 60 through an external terminal connection part 64 of the rear housing 60 to be described later, and can be electrically connected to a terminal of an external device or controller (not shown) to transmit a signal detected by the sensor structure 42 to the external device or controller.

In one embodiment of the present disclosure, a ring-shaped substrate fixing bumper 52 is provided along the circumference of the PCB substrate 51 to couple the PCB substrate 51 to the inner surface of the bracket hole 32.

Referring to FIGS. 4 and 5, the substrate fixing bumper 52 is formed in a circular ring shape and has a [symbol] -shaped cross-section so as to have an accommodation groove 55 on the inner surface in which the outer surface of the PCB substrate 51 is accommodated.

The substrate fixing bumper 52 may be formed of a silicone material.

The outer circumferential surface of the substrate fixing bumper 52 may be fixed in contact with the inner surface 38 of the bracket hole 32. The sensor module 40 may be inserted from the rear side to the front side of the bracket hole 32 and coupled thereto.

According to an embodiment of the present disclosure, the sensor module 40 may be fixed by being inserted until the substrate fixing bumper 52 comes into contact with the step portion 39 located on the front side of the inner surface 38 of the bracket hole 32.

In a state in which the substrate fixing bumper 52 of the sensor module 40 is inserted into the bracket hole 32 so as to be positioned adjacent to the step portion 39 of the bracket hole 32, the side wall portion 65 of the rear housing 60 is inserted into the bracket hole 32 and coupled as shown in FIG. 5, whereby the sensor module 40 can be stably fixed inside the bracket hole 32.

More specifically, according to an embodiment of the present disclosure, the rear housing 60 is coupled to the bracket 30 in order to fix the sensor module 40 inside the bracket hole 32 of the bracket 30.

The rear housing 60 includes a rear housing body 61 having a flat shape facing the PCB substrate 51, and a side wall portion 65 protruding from the rear housing body 61 and coupled to the inner surface 38 of the bracket hole 32.

The rear housing body 61 includes a bottom portion 67 formed in a disc shape, and a rib 68 for reinforcing rigidity may be formed in a grid shape on the bottom portion 67.

A rear housing through hole 63, through which a coupling member 70 passes so as to couple the rear housing body 61 to the bracket 30, may be formed at the circumference of the rear housing body 61.

Meanwhile, a fastening member coupling groove 37 to which the coupling member 70 can be coupled is formed at the circumference of the bracket body of the bracket 30 to be opened toward the rear side. Accordingly, the rear housing 60 can be firmly coupled to the bracket 30 using the coupling member 70.

Meanwhile, according to an embodiment of the present disclosure, a sidewall portion 65 is formed to protrude on a surface of the rear housing body 61 facing the front. The sidewall portion 65 is formed as a cylindrical wall portion, and a sealing member insertion groove 69 is formed on the outer surface of the sidewall portion so that the ring-shaped sealing member 66 is inserted and fixed.

The sealing member 66 is inserted into the sealing member insertion groove 69 and the sidewall portion 65 is fitted into the inner surface of the bracket hole 32, whereby the space between the rear housing 60 and the inner surface 38 of the bracket hole 32 can be sealed.

Meanwhile, the rear housing body 61 has an external terminal connection part 64 formed to protrude on one side of the rear surface thereof so that the terminal part 54 formed on the PCB substrate 51 penetrates and protrudes outward. Accordingly, the rear end of the terminal part 54 may be formed to protrude to the inside of the external terminal connection part 64.

According to an embodiment of the present disclosure, the coupling groove 26 of the front housing 20 is coupled to the coupling protrusion 36 formed in front of the bracket hole 32 of the bracket 30.

In addition, the rear housing 60 is fastened by a coupling member 70 after the side wall portion 65 of the rear housing 60 is inserted into the bracket hole 32 from the rear side of the bracket 30.

Accordingly, the front housing 20 and the rear housing 60 can be firmly coupled to the bracket 30.

The accommodation space 25 inside the front housing 20 is formed so that the sensor structure 42 of the sensor module 40 can be located therein to measure the temperature of the brake disc 1 through the transparent window member 12 provided on the front surface of the front housing 20.

In the temperature sensor structure 10 according to an embodiment of the present disclosure, the front housing 20 in which the sensor structure 42 is disposed can be coupled to the bracket 30 in a simple structure.

In addition, the sensor module 40, which includes the PCB substrate 51 in which the sensor structure 42 is installed, is fixed between the front housing 20 and the rear housing 60 inside the bracket hole 32, whereby the assembly is simple and the inside can be protected to be watertight.

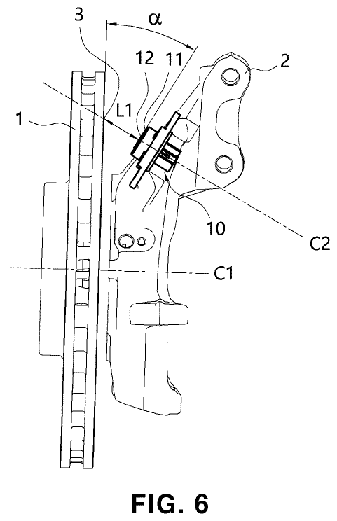

FIG. 6 is a side view showing a surface of a brake disc and an arrangement of a temperature sensor structure in a state in which a temperature sensor structure for a brake disc according to an embodiment of the present disclosure is installed in a knuckle.

In the temperature sensor structure 10 according to an embodiment of the present disclosure, in order to measure the surface temperature of the brake disc 1, as shown in FIG. 6, an angle (α) formed by a plane including the surface of the brake disc 1 and a plane including the front surface 11 of the temperature sensor structure 10 (an angle at which the axis (C2) passing through the center of the sensor is inclined with the opposite surface of the circular brake disc with a central axis of (C1)) may be in a predetermined angle range, for example, 20 degrees to 30 degrees.

In this case, preferably, the angle formed by the plane including the surface of the brake disc 1 and the plane including the front surface 11 of the temperature sensor structure 10 may be about 26 degrees.

Additionally, a distance (L1) by which the front surface of the transparent window member 12 of the temperature sensor structure is spaced apart from the temperature measurement point 3 of the brake disc 1 (or a distance from the front surface of the temperature sensor structure transparent window member 12 to the surface of the brake disc on the axis (C2) passing through the center of the sensor) may range from 35 mm to 40 mm, preferably about 37 mm.

The inclined angle and spaced distance of the temperature sensor structure 10 with respect to the brake disc 1 may vary depending on the performance of the infrared sensor, the location of the brake disc where the temperature sensor structure must be installed, and the vehicle interior structure.

According to the above configuration, the temperature sensor structure for a brake disc according to an embodiment of the present disclosure can accurately measure the temperature of the brake disc by being placed near the brake disc so that dust generated by wear of the brake disc does not accumulate in the temperature sensor structure for the brake disc.

In the temperature sensor structure for a brake disc according to an embodiment of the present disclosure, the temperature sensor of the brake disc is installed inside the housing of the watertight structure, so that the temperature sensor can be safely protected from the external environment.

The temperature sensor structure for a brake disc according to an embodiment of the present disclosure can be easily installed by being coupled to one side of a knuckle of a vehicle adjacent to the brake disc of the vehicle using a bracket coupled to the housing.

The temperature sensor structure for a brake disc according to an embodiment of the present disclosure is formed so that the front housing and the rear housing are coupled to the bracket with a bracket hole formed in the bracket at the center, so that it can be manufactured and assembled in a simple structure.

The temperature sensor structure for a brake disc according to an embodiment of the present disclosure can directly and accurately measure the surface temperature of the brake disc because the sensor is located in the interior space of the front housing of the temperature sensor structure and the sensor is disposed adjacent to the transparent window member formed on the front surface of the front housing to measure the temperature of the brake disc.

It should be understood that the effects of the present disclosure are not limited to the above-described effects and include all effects inferable from a configuration of the invention described in detailed descriptions or claims of the present disclosure.

Although embodiments of the present disclosure have been described, the spirit of the present disclosure is not limited by the embodiments presented in the specification. Those skilled in the art who understand the spirit of the present disclosure will be able to easily suggest other embodiments by adding, changing, deleting, or adding components within the scope of the same spirit, but this will also be included within the scope of the spirit of the present disclosure.

What is claimed is:

1. A temperature sensor structure for a brake disc, comprising:
a front housing having a transparent window member provided on a front surface facing the brake disc;
a sensor module including a sensor for measuring the temperature of the brake disc;
a bracket coupled to the rear of the front housing and supporting the sensor module; and
a rear housing coupled to the rear side of the bracket,
wherein the plane including the transparent window member is disposed to be inclined at a predetermined angle with an opposite surface of the brake disc where the sensor measures the temperature.

2. The temperature sensor structure for a brake disc according to claim 1, wherein the transparent window member includes an IP filter, and the sensor is an IR sensor.

3. The temperature sensor structure for a brake disc according to claim 1, wherein an accommodation groove in which the transparent window member is accommodated is formed on the front surface of the front housing, and the front surface of the transparent window member accommodated in the accommodation groove and the front surface of the front housing is disposed on the same plane.

4. The temperature sensor structure for a brake disc according to claim 1, wherein the sensor module includes:
a PCB substrate, and
the sensor mounted on one surface of the PCB substrate.

5. The temperature sensor structure for a brake disc according to claim 4, wherein the PCB substrate is fixed in a bracket hole formed in the bracket by a substrate fixing member formed at the circumference of the PCB substrate.

6. The temperature sensor structure for a brake disc according to claim 4, wherein the bracket includes:
a bracket body through which the bracket hole is formed toward the front housing; and
an extension portion formed to protrude in both lateral directions on both sides of the bracket hole,
wherein the extension portion has a first through hole through which a predetermined fastening member can pass.

7. The temperature sensor structure for a brake disc according to claim 5, wherein the front housing is formed to have a sensor accommodation space in which the sensor of the sensor module is accommodated, and
the rear end of the front housing is formed to have an opening so that the sensor accommodation space is opened toward the rear side of the front housing,
wherein a coupling part for coupling the front housing to the front of the bracket hole is provided at the circumference of the opening.

8. The temperature sensor structure for a brake disc according to claim 5, wherein the rear housing includes:
a rear housing body having a flat shape facing the PCB substrate; and
a side wall portion protruding from the rear housing body and coupled to the inner surface of the bracket hole.

9. The temperature sensor structure for a brake disc according to claim 8, further including an external terminal connection part extending toward the rear side of the rear housing body,
wherein the PCB substrate is provided with a terminal part so that the sensor can be connected to the outside through the external terminal connection part.

10. The temperature sensor structure for a brake disc according to claim 8, further including a sealing member provided at the outer circumference of the side wall portion to seal between the inner surface of the bracket hole and the side wall portion.

11. The temperature sensor structure for a brake disc according to claim 8, wherein a second through hole is formed at the circumference of the rear housing body so that a predetermined coupling member for fastening the rear housing to the bracket can pass therethrough.

12. The temperature sensor structure for a brake disc according to claim 1, wherein the axis passing through the center of the sensor is formed to meet the axis passing through the center of the brake disc at one point, and the sensor is disposed to be inclined in a direction toward the outside of the brake disc with respect to the brake disc.

13. The temperature sensor structure for a brake disc according to claim 12, wherein the distance from the transparent window member to a point where the axis passing through the center of the sensor meets the surface of the brake disc is in the range of 35 mm to 40 mm, and the angle at which the axis passing through the center of the sensor is inclined with the opposite surface of the brake disc is in the range of 20 to 30 degrees.

14. The temperature sensor structure for a brake disc according to claim 1, wherein the bracket is coupled to one side of a knuckle of a vehicle in which the temperature sensor structure is installed.

15. A temperature sensor structure for a brake disc installed on one side of a vehicle knuckle adjacent to the brake disc to measure the temperature of the brake disc of the vehicle, the temperature sensor structure including:
a housing having a transparent window member disposed to be inclined at a predetermined angle toward the brake disc at the front;
a temperature measurement sensor positioned inside the housing to measure the temperature of the brake disc through the transparent window member; and
a bracket coupled to the housing to couple the housing to the knuckle.

16. The temperature sensor structure for a brake disc according to claim 15, wherein the transparent window member includes an IP filter, and the sensor is an IR sensor.

17. The temperature sensor structure for a brake disc according to claim 15, wherein the front surface of the transparent window member and the front surface of the front housing is disposed on the same plane.

18. The temperature sensor structure for a brake disc according to claim 15, wherein the inside of the housing where the temperature measurement sensor is positioned is formed to have a watertight structure.

19. The temperature sensor structure for a brake disc according to claim 15, wherein the housing includes:
a front housing in which the temperature measurement sensor is positioned and the transparent window member is provided in front of the temperature measurement sensor, and which is coupled to one side of the bracket, and
a rear housing coupled to the other side of the bracket.

20. An electronic parking brake system comprising the temperature sensor structure for a brake disc according to claim 1.
